(19) United States
(12) Patent Application Publication
(10) Pub. No.: US 2021/0386009 A1
(43) Pub. Date: Dec. 16, 2021

(54) SYSTEM AND METHOD FOR ADJUSTING OPERATING PARAMETERS OF AN AGRICULTURAL IMPLEMENT DURING A PRODUCT-DISPENSING OPERATION

(71) Applicant: CNH Industrial Canada, Ltd., Saskatoon (CA)

(72) Inventors: Gordon Anthony Engel, Saskatoon (CA); Anthony Charles Rapley, Saskatoon (CA)

(73) Assignee: CNH Industrial Canada, Ltd.

(21) Appl. No.: 17/336,738

(22) Filed: Jun. 2, 2021

Related U.S. Application Data
(60) Provisional application No. 63/038,362, filed on Jun. 12, 2020.

(51) Int. Cl. A01C 7/10; A01C 21/00; A01C 7/08; A01C 15/04

(52) U.S. Cl. CPC A01C 7/102; A01C 15/04; A01C 7/084; A01C 21/005

(57) ABSTRACT

A method for adjusting operating parameters of an agricultural implement during a product-dispensing operation may include monitoring a location of the agricultural implement while performing a product-dispensing pass across a field. The method may further include determining that the agricultural implement will encounter an operating parameter boundary prescribing a change in an operating parameter of the agricultural implement. Moreover, the method may include determining a transition boundary along the product-dispensing pass based at least in part on a propagation delay for the prescribed change, where the agricultural implement will cross the transition boundary before the operating parameter boundary. Additionally, the method may include initiating the change in the operating parameter when the agricultural implement reaches the transition boundary such that the prescribed change in the operating parameter is complete when the agricultural implement reaches the operating parameter boundary.

### CROSS-REFERENCE TO RELATED APPLICATION

The present disclosure is based upon and claims the right of priority to U.S. Provisional Patent Application No. 63/038,362 filed on Jun. 12, 2020, the entirety of which is incorporated by reference herein for all purposes.

### FIELD OF THE INVENTION

The present disclosure relates generally to agricultural implements and, more particularly, to systems and methods for adjusting operating parameters of an agricultural implement during a product-dispensing operation.

### BACKGROUND OF THE INVENTION

Modern farming practices strive to increase yields of agricultural fields. In this respect, seeders, planters, sprayers, and other agricultural implements are towed behind a tractor or other work vehicle to dispense seed and/or fertilizer throughout a field. For example, seeders typically include one or more ground engaging tools or openers that form a furrow or trench in the soil. One or more dispensing devices of the seeder may, in turn, deposit the seeds, and optionally fertilizer, into the furrow(s). After deposition of the seeds, a packer wheel may pack the soil on top of the deposited seeds.

Typically, an air cart of the seeder is used to meter and deliver seeds, and optionally fertilizer, to the dispensing devices. Particularly, the air cart may include a fan or other pressurized fluid source that generates a flow of pressurized air or fluid to transport the agricultural product(s) from the air cart through a plurality of delivery tubes to the dispensing devices. The operation of the seeder may be controlled based on prescription maps delineating boundaries between areas of the field with different prescribed operating parameter settings. For instance, the seed type being dispensed by the air cart may be changed during the dispensing process for different zones within the field. Similarly, the fan speed may be adjusted depending on the seed type being dispensed or the desired rate of delivery within an area of the field. However, due to a delay or latency caused by the distance between the hopper and the dispensing devices, some of the operating parameters, such as the seed type and the fan speed, cannot instantly change. As such, the real boundaries between areas of the field that were seeded with different operating parameters do not match the prescription map boundaries.

Accordingly, an improved system and method for adjusting operating parameters of an agricultural implement during a product-dispensing operation would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for adjusting operating parameters of an agricultural implement during a product-dispensing operation, where the agricultural implement has a fan configured to generate a flow of pressurized air within a delivery system of the agricultural implement to dispense agricultural product from the delivery system. The method includes operating, with a computing device, the fan of the agricultural implement at a first fan speed associated with dispensing agricultural product at a first dispensing rate as the agricultural implement performs a product-dispensing pass across a field. The method further includes monitoring, with the computing device, a location of the agricultural implement within the field as the agricultural implement performs the product-dispensing pass. Moreover, the method includes determining, with the computing device, that the agricultural implement will encounter an operating parameter boundary along the product-dispensing pass, where the operating parameter boundary separates a first portion of the field where the first dispensing rate is prescribed and a second portion of the field where a second dispensing rate is prescribed, where the second dispensing rate is associated with a second fan speed, and the first dispensing rate differs from the second dispensing rate. Furthermore, the method includes determining, with the computing device, a transition boundary along the product-dispensing pass based at least in part on a propagation delay for a change in fan speed of the fan, where the agricultural implement crosses the transition boundary before the operating parameter boundary along the product-dispensing pass. Additionally, the method includes operating, with the computing device, the fan of the agricultural implement at the second fan speed when the agricultural implement reaches the transition boundary such that the agricultural product is dispensed at the second dispensing rate when the agricultural implement reaches the operating parameter boundary.

In another aspect, the present subject matter is directed to a method for adjusting operating parameters of an agricultural implement during a product-dispensing operation, where the agricultural implement has a pressurized fluid source configured to generate a flow of pressurized fluid within a delivery system of the agricultural implement to dispense agricultural product from the delivery system. The method includes monitoring, with the computing device, a location of the agricultural implement as the agricultural implement performs a product-dispensing pass across a field. The method further includes determining, with the computing device, that the agricultural implement will encounter an operating parameter boundary along the product-dispensing pass, where the operating parameter boundary prescribes a change in an operating parameter of the agricultural implement between a first portion of the field and a second portion of the field. Moreover, the method includes determining, with the computing device, a transition boundary along the product-dispensing pass based at least in part on a propagation delay for the change in the operating parameter, where the agricultural implement crosses the transition boundary before the operating parameter boundary along the product-dispensing pass. Additionally, the method includes initiating, with the computing device, the change in the operating parameter when the agricultural implement reaches the transition boundary such that the change in the operating parameter is complete when the agricultural implement reaches the operating parameter boundary.

In an additional aspect, the present subject matter is directed to a system for adjusting operating parameters of an agricultural implement during a product-dispensing operation. The system includes a delivery system configured to dispense agricultural product as the agricultural implement performs a product-dispensing pass across a field, a fan configured to generate a flow of pressurized air within the delivery system, and a controller communicatively coupled to the fan. The controller is configured to operate the fan at a first fan speed associated with dispensing agricultural product at a first dispensing rate as the agricultural implement performs a product-dispensing pass across a field. The controller is further configured to monitor a location of the agricultural implement as the agricultural implement performs the product-dispensing pass within the field. Moreover, the controller is configured to determine that the agricultural implement will encounter an operating parameter boundary along the product-dispensing pass, where the operating parameter boundary separates a first portion of the field where the first dispensing rate is prescribed and a second portion of the field where a second dispensing rate is prescribed, where the second dispensing rate is associated with a second fan speed, and the first dispensing rate differs from the second dispensing rate. Furthermore, the controller is configured to determine a transition boundary along the product-dispensing pass based at least in part on a propagation delay for a change in fan speed of the fan, where the agricultural implement crosses the transition boundary before the operating parameter boundary along the product-dispensing pass. Additionally, the controller is configured to operate the fan at the second fan speed when the agricultural implement reaches the transition boundary such that the agricultural product is dispensed at the second dispensing rate when the agricultural implement reaches the operating parameter boundary.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a illustrates a perspective view of one embodiment of a work vehicle, an air cart, and an agricultural implement in accordance with aspects of the present subject matter;

FIG. 2 illustrates a side view of the air cart and an alternative embodiment of an agricultural implement in accordance with aspects of the present subject matter;

FIG. 3 illustrates a schematic view of one embodiment of a system for adjusting operating parameters of an agricultural implement in accordance with aspects of the present subject matter;

FIG. 4 illustrates an example view of one embodiment of a prescription map in accordance with aspects of the present subject matter;

FIG. 5 illustrates a graphical view of a transition boundary that may be determined in accordance with aspects of the present subject matter for adjusting operating parameters of an agricultural implement during the performance of a product-dispensing operation;

FIG. 6 illustrates a flow diagram of one embodiment of a method for adjusting operating parameters of an agricultural implement in accordance with aspects of the present subject matter; and

FIG. 7 illustrates a flow diagram of another embodiment of a method for adjusting operating parameters of an agricultural implement in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for adjusting operating parameters of an agricultural implement during a product-dispensing operation. Specifically, in several embodiments, an agricultural implement may include hoppers which supply agricultural product, such as seeds or fertilizer, into delivery tubes for transport to dispensing devices that dispense the product within a field as the agricultural implement performs a product-dispensing pass across the field. A fan or a pump of the agricultural implement generates a pressurized fluid flow through the delivery tubes, where the fan or pump speed is adjustable to control the rate at which the product is dispensed in the field. The product-dispensing pass may be associated with a prescription map defining an operating parameter boundary between areas of the field with one or more differing prescribed operating parameters for the product-dispensing operation. For instance, the operating parameter boundary may delineate areas with different agricultural product types and application rates, which may further be associated with different fan speeds, ground speeds, and/or the like. Due to the length of the delivery tubes, there may be propagation delays for changing some of these operating parameters, particularly product type and fan or pump speed. Thus, in accordance with aspects of the present subject matter, a controller of the disclosed system may be configured to determine a transition boundary that corresponds to a position along the product-dispensing pass, before the operating parameter boundary, at which the operating parameters of the agricultural implement with propagation delays should be adjusted to account for such delays. As such, the operating parameter change(s) is completed as the agricultural implement reaches the operating parameter boundary.

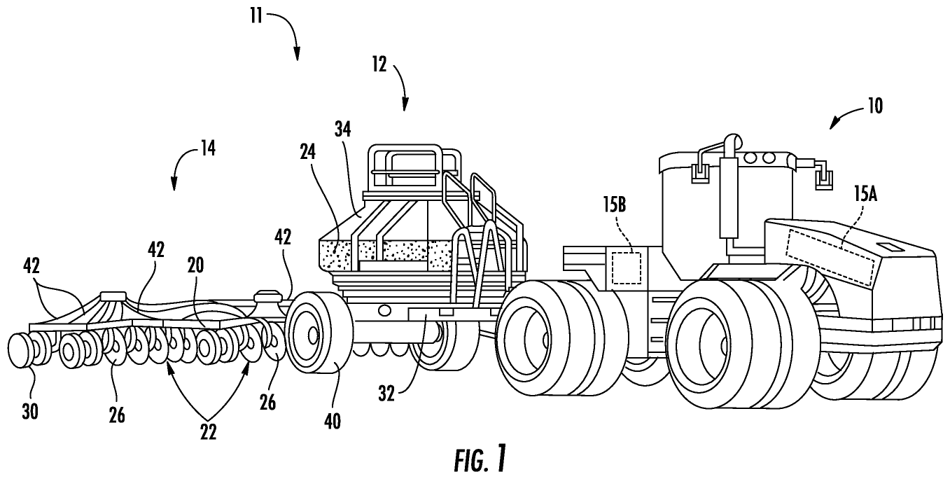

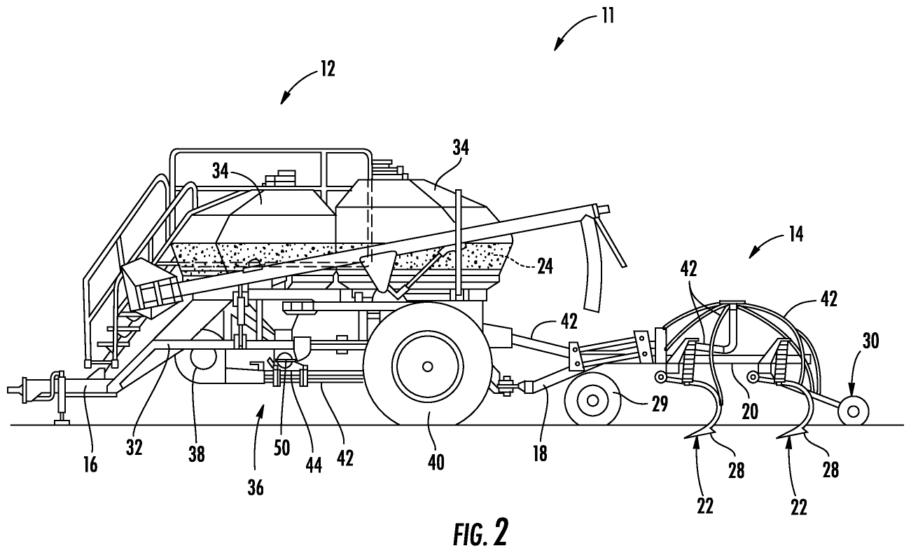

Referring now to FIGS. 1 and 2, embodiments of an agricultural machine including a work vehicle 10, an air cart 12, and an associated ground-engaging implement 14 are illustrated in accordance with aspects of the present subject matter. Specifically, FIG. 1 illustrates a perspective view of the work vehicle 10 towing the air cart 12 and one embodiment of the ground-engaging implement 14. Additionally, FIG. 2 illustrates an enlarged side view of the air cart 12 and another embodiment of the implement 14. The air cart 12 and the implement 14 may collectively form a seed-planting implement 11 (hereafter referred to as “seeder 11”). It should be appreciated that, although the work vehicle 10 illustrated herein is configured as a tractor, the work vehicle 10 may generally be configured as any suitable work vehicle known in the art, such as any other agricultural vehicle, and/or the like. It should also be appreciated that, although the implement 14 illustrated herein corresponds to a seed drill, the implement 14 may generally correspond to any suitable equipment or implement, such as another seed dispensing implement (e.g., a planter), a fertilizer dispensing implement, a tillage implement, and/or the like.

As shown, the air cart 12 may be configured to be towed directly behind the work vehicle 10, with the implement 14 being towed behind the air cart 12. In this regard, a hitch assembly 16 (FIG. 2) may be configured to couple the air cart 12 to the work vehicle 10. Although the hitch assembly 16 is illustrated in FIG. 2 as corresponding to a hitch of the air cart 12, the hitch assembly 16 may also correspond to a hitch of the work vehicle 10. Furthermore, a hitch assembly 18 (FIG. 2) may be configured to couple the implement 14 to the air cart 12. Although the hitch assembly 18 is illustrated as corresponding to a hitch of the implement 14, the hitch assembly 18 may instead correspond to a hitch of the air cart 12. Additionally, in alternative embodiments, the implement 14 may be towed directly behind the work vehicle 10, with the air cart 12 being towed behind the implement 14. For example, in such embodiments, the implement 14 may be coupled to the work vehicle 10 via the hitch assembly 18 and the air cart 12 may be coupled to the implement 14 via the hitch assembly 16. As is generally understood, in such embodiment, the work vehicle 10 may include an engine 15A and a transmission 15B. The transmission 15B may be operably coupled to the engine 26A and may provide variably adjusted gear ratios for transferring engine power to the wheels via a drive axle assembly(ies). The speed at which the air cart 12 and implement 14 are towed may be adjusted by controlling the operation of the engine 15A and/or transmission 15B. In a further embodiment, the air cart 12 and the implement 14 may be part of a single unit that is towed behind the work vehicle 10, or elements of a self-propelled vehicle configured to distribute agricultural product across a field.

In several embodiments, the implement 14 may include a frame 20 configured to support or couple to various components of the implement 14, such as one or more ground-engaging tools 22. In general, the ground-engaging tools 22 may be configured to excavate a furrow or trench in the soil to facilitate deposition of a flowable granular or particulate-type agricultural product 24, such as seeds, fertilizer, and/or the like. For example, in the embodiment illustrated in FIG. 1, each ground-engaging tool 22 may be configured as an opening disc 26. Alternatively, in the embodiment shown in FIG. 2, each ground-engaging tool 22 may be configured as a hoe or shank 28. However, it should be appreciated that the ground-engaging tools 22 may be configured as any suitable device for creating a furrow in the soil that is suitable for receiving the agricultural product 24. Furthermore, the implement 14 may generally include any number of ground-engaging tools 22 to facilitate delivery of the agricultural product 24 across a given swath of the soil. For instance, in one embodiment, the implement 14 may include twenty-four ground-engaging tools 22 spaced apart across the width of the implement 14. In alternative embodiments, however, the implement 14 may include any other suitable number of ground-engaging tools 22, such as less than twenty-four ground-engaging tools 22 or more than twenty-four ground-engaging tools 22. Additionally, the implement 14 may also include one or more closing wheels or discs 30 configured to close the furrow after the agricultural product 24 has been deposited into the furrow.

In accordance with aspects of the present disclosure, the air cart 12 may be configured to store the agricultural product 24 to be deposited within the soil. Specifically, in several embodiments, the air cart 12 may include a frame 32 configured to support or couple to various components of the air cart 12. For example, as shown, the frame 32 may be configured to support a hopper or storage tank 34 configured for storing the agricultural product 24 to be deposited within the furrow. In certain configurations, the hopper 34 may include multiple compartments and/or multiple hoppers 34 may be supported on the frame 32 for storing various different agricultural products. For example, one compartment or hopper may include seeds, and another compartment or hopper may include a dry/granular fertilizer. In some embodiments, the frame 32 may also be configured to support a metering system 36 (FIG. 2) and a fan or pressurized air source 38 (FIG. 2). Additionally, in one embodiment, a plurality of wheels 40 may be coupled to the frame 32 to permit the air cart 12 to be towed across a field by the work vehicle 10.

Furthermore, a plurality of delivery conduits 42 may be configured to convey the agricultural product 24 from the air cart 12 to the implement 14 for deposition into the furrow. Specifically, in several embodiments, the agricultural product 24 contained within the hopper 34 may be gravity fed into the metering system 36. As such, the metering system 36 may be configured to distribute a desired quantity of the agricultural product 24 to the delivery conduits 42. For example, in one embodiment, a primary header 44 (FIG. 2) coupled between the metering system 36 and the delivery conduits 42 may direct the agricultural product 24 into each of the delivery conduits 42. The primary header 44 may include a meter(s) 50, such as a fluted meter(s), which controls the flow from the hopper(s) 34 into the delivery conduits 42, for example, to reduce or stop the supply of agricultural product from the hopper(s) 34 and/or switch between supplies of different agricultural products stored in different compartments or hoppers 34. Pressurized air provided by the fan 38 to the delivery conduits 42 may then carry the agricultural product 24 through the delivery conduits 42 to the implement 14.

It should be appreciated that the fan speed of the fan 38 may be adjustable depending on the seed type being dispensed. For instance, different seed types may require different fan speeds to prevent seed cracking or seed bounce depending on the average size, weight, or shape of the seed type. As such, each seed type may have a prescribed range of fan speeds that are suitable for seed planting operations. It should be appreciated that, in some embodiments, the fan 38 is driven or otherwise powered by fluid flow (e.g., a flow of pressurized hydraulic fluid) from the work vehicle 10. In such embodiments, the fluid flow to the fan 38 may be controlled to adjust the fan speed. However, in other embodiments, the fan 38 may elsewise be driven. For example, the fan 38 may be driven by an electric motor which may be controlled to adjust the fan speed of the fan 38.

It should further be appreciated that the configuration of the work vehicle 10, the air cart 12, and the implement 14 described above and shown in FIGS. 1 and 2 is provided only to place the present subject matter in an exemplary field of use. Thus, it should be appreciated that the present subject matter may be readily adaptable to any manner of agricultural machine configuration. For instance, the present subject matter may be readily adaptable to a sprayer that includes a pump that has a controllable pump speed to vary the pressure with which agricultural product (e.g., liquid fertilizer) is supplied to nozzles for spraying onto a field.

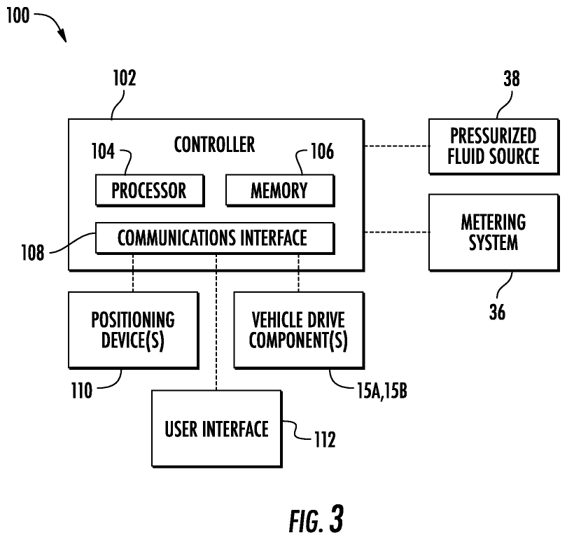

Referring now to FIG. 3, a schematic view of one embodiment of a system 100 for adjusting operating parameters of an agricultural implement during a product-dispensing operation is illustrated in accordance with aspects of the present subject matter. In general, the system 100 will be described herein with reference to the agricultural machine (i.e., the combination of the work vehicle 10, the air cart 12, and the implement 14) described above with reference to FIGS. 1 and 2. However, it should be appreciated by those of ordinary skill in the art that the disclosed system 100 may generally be utilized with agricultural machines having any other suitable machine configuration, such as a sprayer. Additionally, it should be appreciated that the communicative links or electrical couplings of the system 100 shown in FIG. 3 are indicated by dashed lines.

In several embodiments, the system 100 may include a controller 102 and various other components configured to be communicatively coupled to and/or controlled by the controller 102, such as one or more fans or pressurized air sources (e.g., fan 38 of the seeder 11 or a pump of a sprayer), one or more metering systems (e.g., metering system 36 of the seeder 11 or a similar metering system of the sprayer), and one or more vehicle drive components (e.g., the engine 15A and/or the transmission 15B) of the work vehicle 10. Further, in some embodiments, the controller 102 may be communicatively coupled to a positioning system 110 (e.g. a GPS system, a Galileo positioning system, the Global Navigation satellite system (GLONASS), the BeiDou Satellite Navigation and Positioning system, and/or the like), with the positioning system 110 being configured to identify the location of the agricultural machine (e.g., the work vehicle 10, the air cart 12, and/or the implement 14) within the field. Additionally, the controller 102 may be communicatively coupled to a user interface 112 to allow the controller 102 to receive inputs from an operator via the user interface 112 and/or control the operation of the user interface 112. In general, the user interface 112 may be correspond to any suitable input device(s) configured to allow the operator to provide operator inputs to the controller 102, such as a touch screen display, a keyboard, joystick, buttons, knobs, switches, and/or combinations thereof.

As will be described in greater detail below, the controller 102 may be configured to monitor the location of the seeder 11 (or sprayer) within a field relative to an associated prescription map to determine whether the seeder 11 (or sprayer) will encounter an operating parameter boundary (i.e., a boundary between two areas of the field having one or more different prescribed operating parameters) along a given product-dispensing pass being made across the field. In the event that it is determined that the seeder 11 (or sprayer) will encounter an operating parameter boundary, the controller 102 may be configured to determine a transition boundary. The transition boundary is spaced apart from the operating parameter boundary along the product-dispensing pass, such that the seeder 11 (or sprayer) passes the transition boundary before the operating parameter boundary. The transition boundary is generally selected based on delays for adjusting the operating parameter(s). The controller 102 is configured to initiate the prescribed adjustment(s) in the operating parameter(s) once the seeder 11 (or sprayer) has reached the transition boundary, (e.g., by controlling the operation of one or more components of the system, such as the fan 38, the metering system 36, and/or the vehicle drive components 15A, 15B of the seeder 11 or the pump, similar metering system, and/or drive components of a sprayer), so that, by the time the seeder 11 (or sprayer) reaches the operating parameter boundary, the changes in the operating parameter(s) are complete.

In general, the controller 102 may comprise any suitable processor-based device known in the art, such as a computing device or any suitable combination of computing devices. Thus, in several embodiments, the controller 102 may include one or more processor(s) 104 and associated memory device(s) 106 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 106 of the controller 102 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 106 may generally be configured to store suitable computer-readable instructions that, when implemented by the processor(s) 104, configure the controller 102 to perform various computer-implemented functions.

It should be appreciated that the controller 102 may correspond to an existing controller(s) of the vehicle 10, the air cart 12, and/or the implement 14, itself, or the controller 102 may correspond to a separate processing device. For instance, in one embodiment, the controller 102 may form all or part of a separate plug-in module that may be installed in association with the vehicle 10, the air cart 12, and/or the implement 14 to allow for the disclosed systems to be implemented without requiring additional software to be uploaded onto existing control devices of the vehicle 10, the air cart 12, and/or the implement 14. As such, the controller 102 may be positioned on and/or within or otherwise associated with the vehicle 10, air cart 12, or implement 14.

It should also be appreciated that the functions of the controller 102 may be performed by a single processor-based device or may be distributed across any number of processor-based devices, in which instance such devices may be considered to form part of the controller 102. For instance, the functions of the controller 102 may be distributed across multiple application-specific controllers, such as a vehicle controller, an air cart controller, an implement controller, and/or the like. For example, the functions of the controller 102 may be implemented using ISOBUS class 3 control or vehicle-implement interface, where the operation of the elements of the air cart 12 and/or the implement 14 are controllable by a vehicle-based controller of the work vehicle 10, which is also configured to control the operations of the work vehicle 10, or where the operation of one or more components of the work vehicle 10 are controllable by an implement-based controller, which is also configured to control the operations of the air cart 12 and/or the implement 14.

In some embodiments, the controller 102 may also include various other suitable components, such as a communications circuit or module, a network interface, one or more input/output channels, a data/control bus and/or the like, to allow controller 102 to be communicatively coupled to any of the various other system components described herein. For instance, as shown in FIG. 3, a communicative link or interface 108 (e.g., a data bus) may be provided to allow the controller 102 to communicate with the other components of the system 100 via any suitable communications protocol (e.g., CAN bus).

As indicated above, the controller 102 may be configured to monitor the current location of the seeder 11 (or sprayer) with respect to a prescription map (e.g., stored in the memory 106 of the controller 102, or otherwise accessible by the controller 102) associated with performing a product-dispensing operation within a field. For instance, in one embodiment, the controller 102 may particularly monitor the location of the implement 14 of the seeder 11 or of the sprayer with respect to the prescription map. However, the controller 102 may monitor any other suitable portion of the seeder 11 (e.g., air cart 12) or of the sprayer relative to the prescription map. As is generally understood, the prescription map may divide a field into two or more operating parameter zones, with each operating parameter zone specifying operating parameters for dispensing the agricultural product in the area of the field encompassed by such zone. For instance, each operating parameter zone may specify operating parameters such as a product type (seed type, fertilizer type, combination of fertilizer and seed, and/or the like), a dispensing rate, and/or the like. An operating parameter boundary may be defined within the prescription map at the intersection of adjacent operating parameter zones. The operating parameter boundary often corresponds to the location at which one or more of the operating parameters is to be changed.

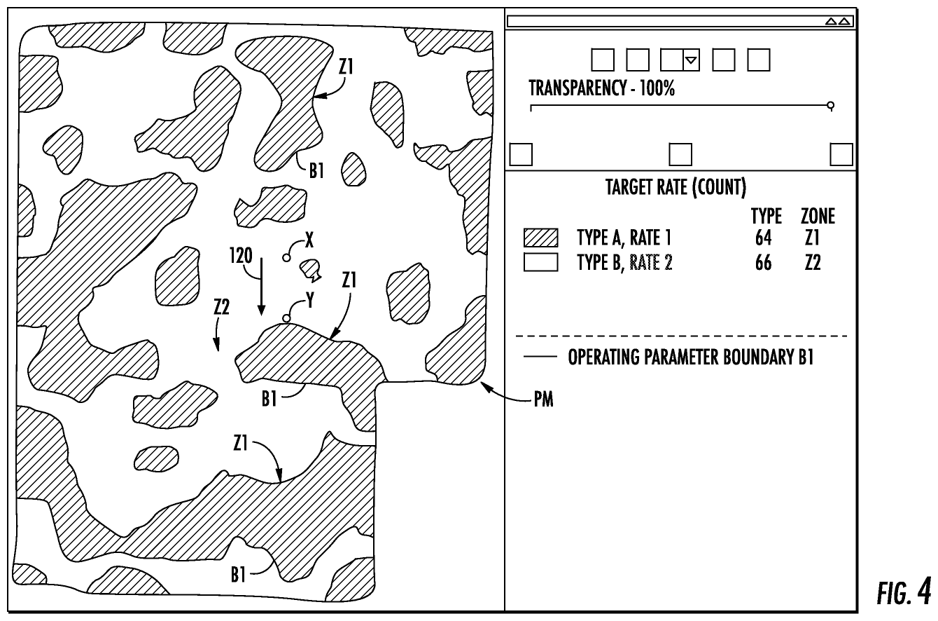

For instance, an example prescription map (PM) is shown in FIG. 4. As shown, the prescription map PM identifies the location of operating parameter zones Z1, Z2 in the agricultural field. Each operating parameter zone Z1, Z2 is associated with an agricultural product type and a rate (e.g., pound per acre) for dispensing such product. As shown in FIG. 4, in this embodiment, agricultural product (e.g., seeds or fertilizer) of a first type, corresponding to a recommended type A, are shown as being acceptable for use in zones Z1 and are recommended to be dispensed at a first rate, corresponding to rate 1. Similarly, agricultural product (e.g., seeds or fertilizer) of a second type, corresponding to a recommended type B, are shown as being acceptable for use in zones Z2 and are recommended to be dispensed at a second rate, corresponding to rate 2. Additionally, as shown in FIG. 4, an operating parameter boundary B1 is defined at each intersection or interface defined between adjacent zones Z1, Z2. Thus, when transitioning from the first zone Z1 to the second zone Z2 or vice versa, the operating parameter boundary B1 may generally define the location at which the agricultural product type being distributed is to be switched and the dispensing rate is to be changed. For example, assuming the seeder 11 or sprayer is located at position X within the field and is traveling in a travel direction indicated by arrow 120, the prescription map PM specifies a switch from dispensing the second product type B at the second rate 2 to dispensing the first product type A at the first rate 1 as the seeder 11 or sprayer crosses the operating parameter boundary B1 defined between the second zone Z2 and the first zone Z1 at location Y. However, as will be described in greater detail below, due to propagation delays in some operating parameter changes, such operating parameter changes are not initiated at the operating parameter boundary.

It should be appreciated that, while a prescribed change in one of the operating parameters (e.g., product type) may be associated with a prescribed change in another operating parameter (e.g., dispensing rate) as shown in the prescription map PM, the operating parameters may also be adjusted independently of each other. For example, a change in dispensing rate may be prescribed without a change in product type.

As indicated above, in accordance with aspects of the present subject matter, changes in some operating parameters are not instantaneous. For instance, changes in product type or a change in fan or pump speed derived from a prescribed change in dispensing rate are not instantaneous. Instead, there is a significant propagation delay between when such operating parameters are changed and when the operating parameter changes are realized. For instance, due to the length of the delivery conduits 42, it may take a period of time for a change in the product type or fan speed to be fully completed. As such, the controller 102 may be configured to determine a transition boundary which is offset from the operating parameter boundary B1 based at least in part on the propagation delay of the delivery system. In some embodiments, the propagation delay may be obtained, for example, by conducting experiments in which an operating parameter(s) is changed and the amount of time it takes for the product-dispensing operation to regain steady state is monitored. This process may be repeated multiple times for each parameter to obtain an average propagation time for each parameter. Such propagation delay(s) may be input by an operator, for example, via the user interface 112 in communication with the controller 102 or may otherwise be input to the controller 102. Based on the ground speed of the agricultural machine and the propagation time for the parameter(s) to be changed at the operating parameter boundary, the controller 102 may determine the location of the transition boundary along the product-dispensing pass.

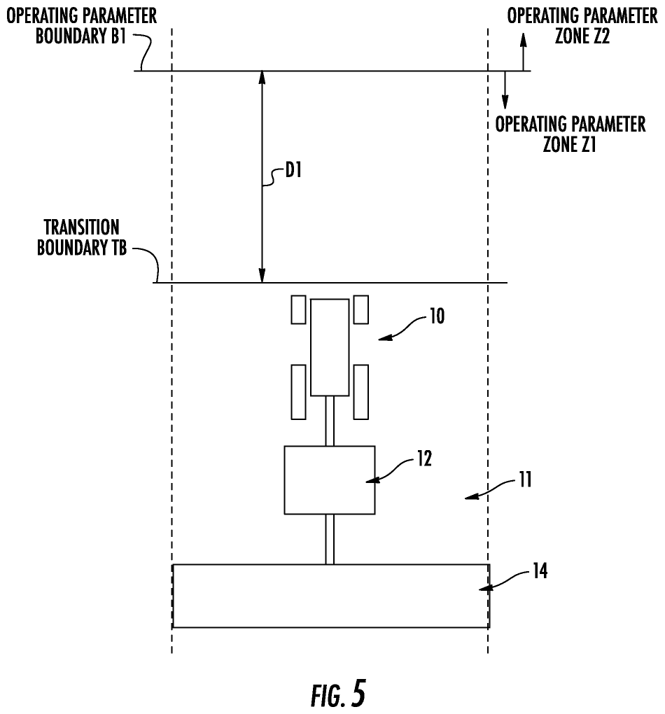

A graphical example of a transition boundary that may be defined by the controller 102 relative to a given operating parameter boundary is illustrated in FIG. 5. Similar to that shown in FIG. 4, the operating parameter boundary (indicated by line B1 in FIG. 5) is defined between the first operating parameter zone Z1 and the second operating parameter zone Z2, wherein at least one prescribed operating parameter between the first and second zones Z1, Z2 changes. Additionally, as shown in FIG. 5, the agricultural machine is traveling along a product-dispensing pass within the field such that the seeder 11 or sprayer will encounter the operating parameter boundary B1 as it moves from the first zone Z1 to the second zone Z2, thereby requiring a change in the operating parameter(s) of the product-dispensing operation. Due to the propagation delay for changes in certain operating parameters or associated with such operating parameters (e.g., seed type, fan or pump speed, and/or the like), a transition boundary TB may be defined corresponding to the location along the product-dispensing pass where a change in the operating parameter(s) should be initiated such that, by the time the seeder 11 (particularly the implement 14 of the seeder 11) or sprayer crosses the operating parameter boundary B1, the change(s) in the operating parameter(s) are complete. In some embodiments, the changes in the operating parameter(s) are completed when the seeder 11 or sprayer reaches the operating parameter boundary B1. More particularly, as shown in FIG. 5, the transition boundary TB is offset from the operating parameter boundary B1 by an offset distance D1, where the offset distance D1 is selected based at least in part on the propagation delay, the position of the seeder 11 or sprayer relative to the operating parameter boundary B1, and the ground speed of the agricultural machine.

Referring back to FIG. 3, instructions stored within the memory 106 may also be executed by the processor 104 to initiate the prescribed changes in the operating parameter(s). Specifically, in several embodiments, the controller 102 may be configured to monitor the location of the seeder 11 or sprayer relative to the transition boundary TB. Once the seeder 11 or sprayer reaches the transition boundary TB, the controller 102 may be configured to control the operation of the seeder 11 or sprayer to begin the transition to the operating parameters requested at the operating parameter boundary B1. For instance, if an upcoming operating parameter boundary B1 is associated with a change in seed type, the controller 102 may be configured to control the operation of the metering system 36 (e.g., the meter(s) 50 of the metering system 36) to switch between seed types when the seeder 11 or sprayer reaches the associated transition boundary TB, and/or increase or decrease the speed of the meter(s) 50 to increase or decrease the supply of seeds or fertilizer. Similarly, if an upcoming operating parameter boundary B1 is associated with a change in fan or pump speed, the controller 102 may be configured to control the operation of the fan 38 or pump to adjust the fan or pump speed when the seeder 11 or sprayer reaches the associated transition boundary TB. It should further be appreciated that, by initiating such changes in operating parameter at the transition boundary TB, the prescribed change in operating parameter is complete when the seeder 11 or sprayer passes the associated operating parameter boundary B1. Thus, the product-dispensing operation of the seeder 11 or sprayer may more reliably follow the prescription map, which may increase yields.

Additionally, in some embodiments, the controller 102 may further be configured to control the ground speed of the agricultural machine. For instance, in some instances, the difference between prescribed dispensing rates of adjacent zones of a field is greater than the fan or pump speed range(s) for the product type(s) being dispensed in the adjacent zones will allow without changing the ground speed of the vehicle. Conversely, in some instances, the difference between fan or pump speed range(s) of the product type(s) being dispensed in adjacent zones of a field is greater than the difference between prescribed dispensing rate(s) of the adjacent zones will allow without changing the ground speed of the vehicle. In either instance, the ground speed between adjacent zones needs to be adjusted to enable such changes.

As such, the controller 102 may be configured to determine a new ground speed for the seeder 11 or sprayer based at least in part on the prescribed dispensing rate(s) and preferred fan speed range(s) for the product type(s) being dispensed in adjacent zones of the field. The controller 102 may then control the operation of the vehicle drive component(s) 15A, 15B of the work vehicle 10 to adjust the ground speed of the seeder 11 or sprayer. It should be appreciated that the change in ground speed of the seeder 11 or sprayer may have a relatively small propagation delay in comparison to the propagation delays of the fan speed and/or product type. As such, the controller 102 may be configured to adjust the ground speed of the seeder 11 or sprayer at or immediately before the operating parameter boundary B1 instead of at the transition boundary TB.

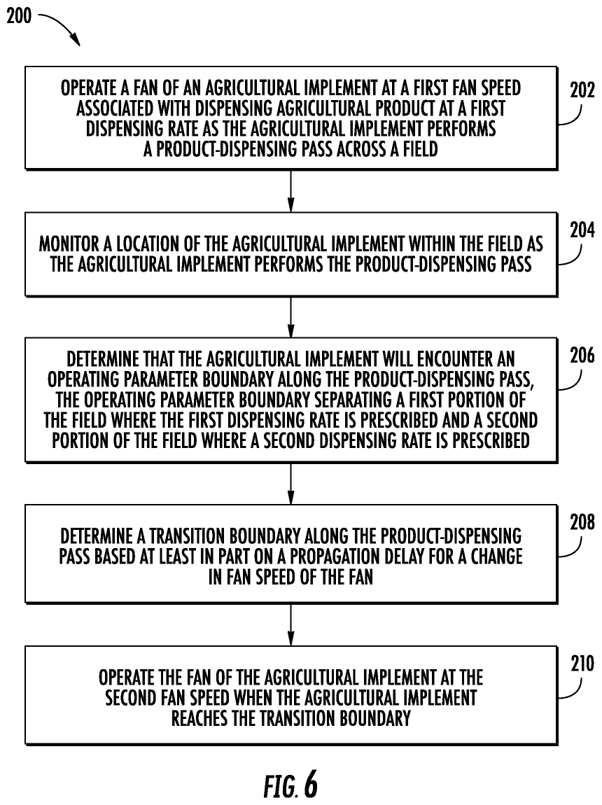

Referring now to FIG. 6, a flow diagram of one embodiment of a method 200 for adjusting operating parameters of an agricultural implement during a product-dispensing operation is illustrated in accordance with aspects of the present subject matter. In general, the method 200 will be described herein with reference to the work vehicle 10, the air cart 12, and the implement 14 shown in FIGS. 1 and 2, as well as the various system components shown in FIG. 3. However, it should be appreciated that the disclosed method 200 may be implemented with work vehicles, air carts, and/or implements having any other suitable configurations and/or within systems having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 6, at (202), the method 200 may include operating a fan of the agricultural implement at a first fan speed associated with dispensing agricultural product at a first dispensing rate as the agricultural implement performs a product-dispensing pass across a field. For instance, as described above, the controller 102 may be configured to operate the fan 38 of the seeder 11 at a first fan speed to dispense agricultural product, such as seeds, granular fertilizer, and/or the like at a dispensing rate associated with the first fan speed as the seeder 11 performs a product-dispensing pass across the field.

Further, at (204), the method 200 may include monitoring a location of the agricultural implement within the field as the agricultural implement performs the product-dispensing pass. For example, as described above, the controller 102 may be configured to receive inputs from the positioning system 110 configured to identify the location of the seeder 11 within the field as the seeder 11 performs the product-dispensing pass.

Furthermore, at (206), the method 200 may include determining that the agricultural implement will encounter an operating parameter boundary along the product-dispensing pass, the operating parameter boundary separating a first portion of the field where the first dispensing rate is prescribed and a second portion of the field where a second dispensing rate is prescribed. For example, the controller 102 may correlate the location of the seeder 11 to a position on a prescription map PM dividing the field into two or more operating parameter zones Z1, Z2 using an operating parameter boundary B1, with each operating parameter zone Z1, Z2 specifying a first dispensing rate associated with a first fan speed and a second dispensing rate associated with a second fan speed, respectively.

Moreover, at (208), the method 200 may include determining a transition boundary along the product-dispensing pass based at least in part on a propagation delay for a change in fan speed of the fan. For example, as described above, the controller 102 may determine a transition boundary TB corresponding to a location along the product-dispensing pass where the fan speed is changed such that, by the time the seeder 11 crosses the operating parameter boundary B1, the change in the fan speed is complete. The transition boundary TB is offset from the operating parameter boundary B1 by an offset distance D1, where the offset distance D1 is selected based at least in part on the propagation delay, the position of the seeder 11 relative to the operating parameter boundary B1, and the ground speed of the agricultural machine.

Additionally, at (210), the method 200 may include operating the fan of the agricultural implement at the second fan speed when the agricultural implement reaches the transition boundary. For instance, as described above, the controller 102 may be configured to operate the fan 38 of the seeder 11 at the second fan speed when the seeder 11 reaches the transition boundary TB such that the agricultural product is dispensed at the second dispensing rate when the seeder 11 reaches the operating-parameter boundary B1.

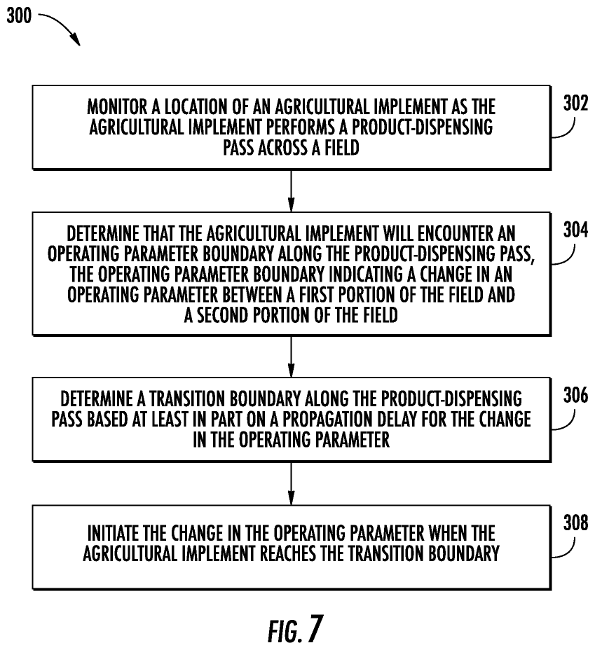

Referring now to FIG. 7, a flow diagram of another embodiment of a method 300 for adjusting operating parameters of an agricultural implement during a product-dispensing operation is illustrated in accordance with aspects of the present subject matter. In general, the method 300 will be described herein with reference to the work vehicle 10, the air cart 12, and the implement 14 shown in FIGS. 1 and 2, as well as the various system components shown in FIG. 3. However, it should be appreciated that the disclosed method 300 may be implemented with work vehicles, air carts, and/or implements having any other suitable configurations and/or within systems having any other suitable system configuration, such as a sprayer. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 7, at (302), the method 300 may include monitoring a location of an agricultural implement as the agricultural implement performs a product-dispensing pass across a field. For example, as described above, the controller 102 may be configured to receive inputs from the positioning system 110 configured to identify the location of the seeder 11 or a sprayer within the field.

Further, at (304), the method 300 may include determining that the agricultural implement will encounter an operating parameter boundary along the product-dispensing pass, the operating parameter boundary indicating a change in an operating parameter between a first portion of the field and a second portion of the field. For example, the controller 102 may correlate the location of the seeder 11 (or sprayer) to a location on a prescription map PM dividing the field into two or more operating parameter zones Z1, Z2 using an operating parameter boundary B1, with each operating parameter zone Z1, Z2 specifying at least one differing operating parameter.

Moreover, at (306), the method 300 may include determining a transition boundary along the product-dispensing pass based at least in part on a propagation delay for the change in the operating parameter. For example, as described above, the controller 102 may define a transition boundary TB corresponding to the location along the product-dispensing pass where the operating parameter is changed such that, by the time the seeder 11 (or sprayer) crosses the operating parameter boundary B1, the operating parameter change is complete. The transition boundary TB is offset from the operating parameter boundary B1 by an offset distance D1, where the offset distance D1 is selected based at least in part on the propagation delay, the position of the seeder 11 (or sprayer) relative to the operating parameter boundary B1, and the ground speed of the agricultural machine.

Additionally, at (308), the method 300 may include initiating the change in the operating parameter when the agricultural implement reaches the transition boundary. For instance, as described above, the controller 102 may be configured to control the metering system 36 and/or the fan 38 (of the metering system and/or pump of the sprayer) when the seeder 11 (or sprayer) reaches the transition boundary TB such that agricultural product type change and/or fan (or pump) speed change associated with a dispensing rate change is completed when the seeder 11 (or sprayer) reaches the operating-parameter boundary B1.

It is to be understood that the steps of the method 200, 300 are performed by the controller 102 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the controller 102 described herein, such as the method 200, 300 is implemented in software code or instructions which are tangibly stored on a tangible computer readable medium. The controller 102 loads the software code or instructions via a direct interface with the computer readable medium or via a wired and/or wireless network. Upon loading and executing such software code or instructions by the controller 102, the controller 102 may perform any of the functionality of the controller 102 described herein, including any steps of the method 200, 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for adjusting operating parameters of an agricultural implement during a product-dispensing operation, the agricultural implement having a fan configured to generate a flow of pressurized air within a delivery system of the agricultural implement to dispense agricultural product from the delivery system, the method comprising:
operating, with a computing device, the fan of the agricultural implement at a first fan speed associated with dispensing agricultural product at a first dispensing rate as the agricultural implement performs a product-dispensing pass across a field;
monitoring, with the computing device, a location of the agricultural implement within the field as the agricultural implement performs the product-dispensing pass;
determining, with the computing device, that the agricultural implement will encounter an operating parameter boundary along the product-dispensing pass, the operating parameter boundary separating a first portion of the field where the first dispensing rate is prescribed and a second portion of the field where a second dispensing rate is prescribed, the second dispensing rate being associated with a second fan speed, the first dispensing rate differing from the second dispensing rate;
determining, with the computing device, a transition boundary along the product-dispensing pass based at least in part on a propagation delay for a change in fan speed of the fan, the agricultural implement crossing the transition boundary before the operating parameter boundary along the product-dispensing pass; and
operating, with the computing device, the fan of the agricultural implement at the second fan speed when the agricultural implement reaches the transition boundary such that the agricultural product is dispensed at the second dispensing rate when the agricultural implement reaches the operating parameter boundary.

2. The method of claim 1, wherein the agricultural product comprises a supply of a first agricultural product dispensed at the first dispensing rate and a supply of a second agricultural product dispensed at the second dispensing rate, the method further comprising:
discontinuing, with the computing device, the supply of the first agricultural product when the agricultural implement reaches the transition boundary; and initiating, with the computing device, the supply of the second agricultural product when the agricultural implement reaches the transition boundary.

3. The method of claim 2, wherein discontinuing the supply of the first agricultural product and initiating the supply of the second agricultural product comprises actively controlling the operation of a metering system provided in operative association with the delivery system.

4. The method of claim 1, further comprising actively controlling the operation of a metering system provided in operative association with the delivery system to increase or decrease a supply of the agricultural product.

5. The method of claim 1, further comprising adjusting, with the computing device, a ground speed of the agricultural implement.

6. The method of claim 4, wherein adjusting the ground speed of the agricultural implement comprises adjusting the ground speed of the agricultural implement when the agricultural implement reaches the operating parameter boundary.

7. The method of claim 1, wherein the transition boundary is determined based at least in part on a ground speed of the agricultural implement and the location of the agricultural implement relative to the operating parameter boundary.

8. The method of claim 1, further comprising receiving, with the computing device, an input indicative of the propagation delay of the delivery system via a user interface.

9. The method of claim 1, further comprising accessing, with the computing device, a prescription map associated with the field to determine that the agricultural implement will encounter the operating parameter boundary along the product-dispensing pass.

10. A method for adjusting operating parameters of an agricultural implement during a product-dispensing operation, the agricultural implement having a pressurized fluid source configured to generate a flow of pressurized fluid within a delivery system of the agricultural implement to dispense agricultural product from the delivery system, the method comprising:
monitoring, with the computing device, a location of the agricultural implement as the agricultural implement performs a product-dispensing pass across a field;
determining, with the computing device, that the agricultural implement will encounter an operating parameter boundary along the product-dispensing pass, the operating parameter boundary prescribing a change in an operating parameter of the agricultural implement between a first portion of the field and a second portion of the field;
determining, with the computing device, a transition boundary along the product-dispensing pass based at least in part on a propagation delay for the change in the operating parameter, the agricultural implement crossing the transition boundary before the operating parameter boundary along the product-dispensing pass; and
initiating, with the computing device, the change in the operating parameter when the agricultural implement reaches the transition boundary such that the change in the operating parameter is complete when the agricultural implement reaches the operating parameter boundary.

11. The method of claim 10, wherein the pressurized fluid source is a fan or a pump.

12. A system for adjusting operating parameters of an agricultural implement during a product-dispensing operation, the system comprising:
a delivery system configured to dispense agricultural product as the agricultural implement performs a product-dispensing pass across a field;
a fan configured to generate a flow of pressurized air within the delivery system; and
a controller communicatively coupled to the fan, the controller being configured to:
operate the fan at a first fan speed associated with dispensing agricultural product at a first dispensing rate as the agricultural implement performs a product-dispensing pass across a field;
monitor a location of the agricultural implement as the agricultural implement performs the product-dispensing pass within the field;
determine that the agricultural implement will encounter an operating parameter boundary along the product-dispensing pass, the operating parameter boundary separating a first portion of the field where the first dispensing rate is prescribed and a second portion of the field where a second dispensing rate is prescribed, the second dispensing rate being associated with a second fan speed, the first dispensing rate differing from the second dispensing rate;
determine a transition boundary along the product-dispensing pass based at least in part on a propagation delay for a change in fan speed of the fan, the agricultural implement crossing the transition boundary before the operating parameter boundary along the product-dispensing pass; and
operate the fan at the second fan speed when the agricultural implement reaches the transition boundary such that the agricultural product is dispensed at the second dispensing rate when the agricultural implement reaches the operating parameter boundary.

13. The system of claim 12, wherein the agricultural product comprises a supply of a first agricultural product dispensed at the first dispensing rate and a supply of a second agricultural product dispensed at the second dispensing rate, the controller being further configured to:
discontinue the supply of the first agricultural product when the agricultural implement reaches the transition boundary; and
initiate the supply of the second agricultural product when the agricultural implement reaches the transition boundary.

14. The system of claim 13, further comprising a metering system provided in operative association with the delivery system,
wherein the controller is configured to discontinue the supply of the first agricultural product and initiate the supply of the second agricultural product by actively controlling the operation of the metering system.

15. The system of claim 12, further comprising a metering system provided in operative association with the delivery system, the controller being further configured to actively control the metering system to increase or decrease a supply of the agricultural product.

16. The system of claim 12, wherein the controller is further configured to adjust a ground speed of the agricultural implement.

17. The system of claim 16, wherein the controller is configured to adjust the ground speed of the agricultural implement when the agricultural implement reaches the operating parameter boundary.

18. The system of claim 12, wherein the transition boundary is determined based at least in part on a ground speed of the agricultural implement and the location of the agricultural implement relative to the operating parameter boundary.

19. The system of claim 12, further comprising a user interface communicatively coupled to the controller, the controller being configured to receive an input indicative of the propagation delay from an operator via the user interface.

20. The system of claim 12, wherein the controller is further configured to access a prescription map associated with the field to determine that the agricultural implement will encounter the operating parameter boundary along the product-dispensing pass.
